(19) United States
(12) Patent Application Publication
(10) Pub. No.: US 2025/0306531 A1
(43) Pub. Date: Oct. 2, 2025

(54) IMAGE-FORMING APPARATUS INCLUDING FAN CONFIGURED TO DISCHARGE AIR THROUGH LOUVER ON HOUSING AND FILTER POSITIONED BETWEEN FAN AND LOUVER IN AIR DISCHARGING DIRECTION

(71) Applicant: BROTHER KOGYO KABUSHIKI KAISHA, Nagoya (JP)

(72) Inventors: Takuya TSUJI, Nagoya (JP); Masakazu OKAWA, Nagoya (JP)

(73) Assignee: BROTHER KOGYO KABUSHIKI KAISHA, Nagoya (JP)

(21) Appl. No.: 19/089,787

(22) Filed: Mar. 25, 2025

(30) Foreign Application Priority Data
Mar. 28, 2024 (JP) 2024-054016

(51) Int. Cl. G03G 21/20; G03G 21/16

(52) U.S. Cl. CPC G03G 21/206; G03G 21/1652

(57) ABSTRACT

An image-forming apparatus includes a housing, a louver provided on the housing, a fan for discharging air inside the housing in a discharging direction to an outside of the housing, a duct accommodating the fan, a filter, and a first elastic member. The fan is positioned upstream of the louver in the discharging direction. The filter is positioned between the fan and the louver in the discharging direction. The first elastic member is positioned between the duct and the filter and between the fan and the filter in the discharging direction. The first elastic member is in contact with the filter and at least one of a downstream end of the duct and a downstream end of the fan in the discharging direction.

### REFERENCE TO RELATED APPLICATIONS

This application claims priority from Japanese Patent Application No. 2024-054016 filed on Mar. 28, 2024. The entire content of the priority application is incorporated herein by reference.

### BACKGROUND ART

A conventional image-forming apparatus includes a fan for discharging air inside a housing, a duct for guiding the air from the fan toward a discharge opening formed in an exterior member constituting the housing, and a filter positioned downstream of the fan in an air discharging direction. The filter is configured to trap dusts contained in the air to remove the dusts from the air discharged by the fan. The filter is interposed between the duct and the exterior member to be held therebetween.

### SUMMARY

In the above-described conventional image-forming apparatus, the downstream end of the duct in the air discharging direction is pressed against the filter. Hence, conceivably, the filter may be pushed by the downstream end of the duct if an external force is imparted on the exterior member of the housing. As a result, dusts and particles such as powdered catalyst contained in the filter may be scattered out of the filter, which is likely to exert a negative influence on neighboring components accommodated in the housing.

In view of the foregoing, it is an object of the present disclosure to provide an image-forming apparatus capable of restraining particles trapped in the filter from scattering out of the filter.

In order to attain the above and other objects, according to one aspect, the present disclosure provides an image-forming apparatus including a housing, a fan, a duct, a filter, and a first elastic member. The housing has a louver. The fan is positioned inside the housing and is configured to discharge air inside the housing in a discharging direction to an outside of the housing through the louver. The fan is positioned upstream of the louver in the discharging direction. The fan has a first downstream end in the discharging direction. The duct extends in the discharging direction and accommodates the fan therein. The duct has a second downstream end in the discharging direction. The filter is positioned between the fan and the louver in the discharging direction. The first elastic member is positioned between the filter and each of the fan and the duct in the discharging direction. The first elastic member is in contact with the filter and at least one of the second downstream end of the duct and the first downstream end of the fan.

With this structure, the first elastic member can absorb the pressure applied to the filter from the duct upon application of an external force to the housing, thereby restraining particles trapped in the filter from being released therefrom. Further, the first elastic member can suppress displacement of the filter in response to application of an external force to the housing.

### BRIEF DESCRIPTION OF DRAWINGS

FIG. 1 is a schematic cross-sectional view of an image-forming apparatus according to one embodiment.

FIG. 2 is a perspective view of the image-forming apparatus.

FIG. 3 is a plan view of the image-forming apparatus.

FIG. 4 is an exploded perspective view illustrating a fan and a discharge filter both of which are assembled to a right frame, and a louver formed in a right side wall.

FIG. 5 is a cross-sectional view of a portion of the image-forming apparatus taken along a line V-V in FIG. 3.

FIG. 6 is a partial perspective view of the portion of the image-forming apparatus taken along the line V-V in FIG. 3.

FIG. 7 is a side view illustrating a first louver of the right side wall.

FIG. 8 is a cross-sectional side view illustrating a first duct and a first discharge filter accommodated on the inside of an accommodation wall of the right side wall as viewed from an interior of the housing.

FIG. 9 is a partial cross-sectional view of a portion of the image-forming apparatus taken along a line IX-IX in FIG. 3.

FIG. 10 is a perspective view illustrating the first duct formed in the right frame as viewed from the interior of the housing.

FIG. 11 is a transverse cross-sectional view illustrating the first louver of the right side wall and the first duct of the right frame.

FIG. 12 is a cross-sectional view of a portion of the image-forming apparatus taken along a line XII-XII in FIG. 3.

FIG. 13 is a side view illustrating two first elastic members respectively positioned at two opposing diagonal corners of the rectangular-shaped first duct.

FIG. 14 is a cross-sectional view of a portion of the image-forming apparatus taken along a line XIV-XIV in FIG. 3.

FIG. 15 is a side view illustrating the first discharge filter and a second elastic member accommodated on the inside of the accommodation wall of the right side wall as viewed from the interior of the housing.

FIG. 16 is a perspective view illustrating the first discharge filter and the second elastic member accommodated on the inside of the accommodation wall of the right side wall as viewed from the interior of the housing.

FIG. 17 is a front cross-sectional view illustrating a buffer according to a modification to the embodiment.

FIG. 18 is a perspective view illustrating the buffer according to the modification to the embodiment.

### DESCRIPTION

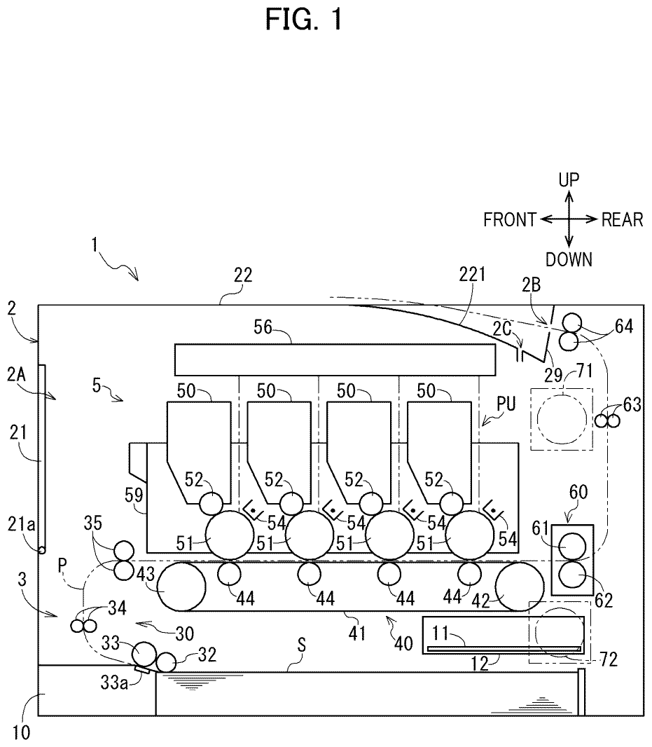

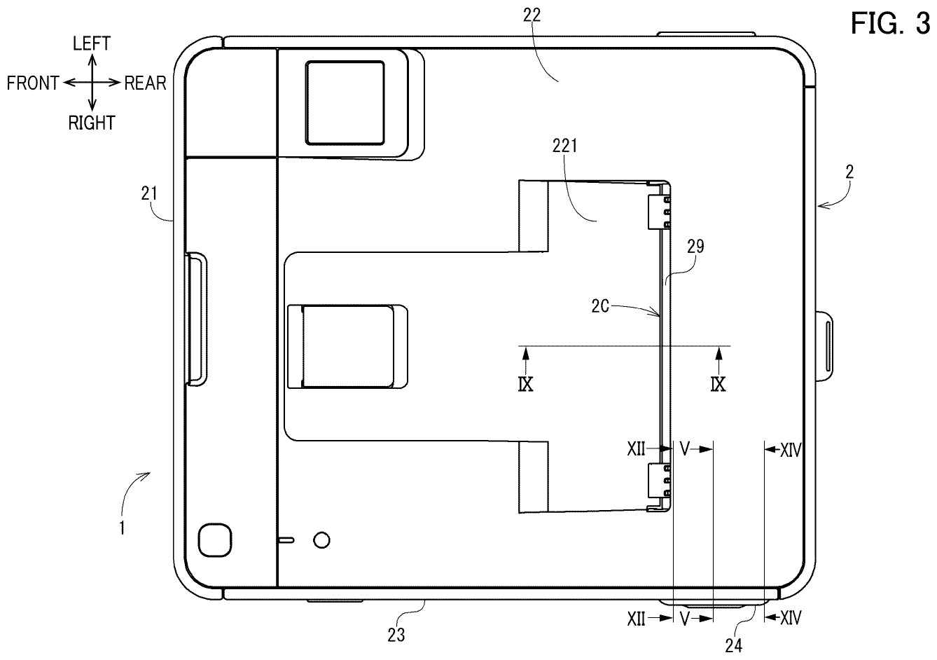

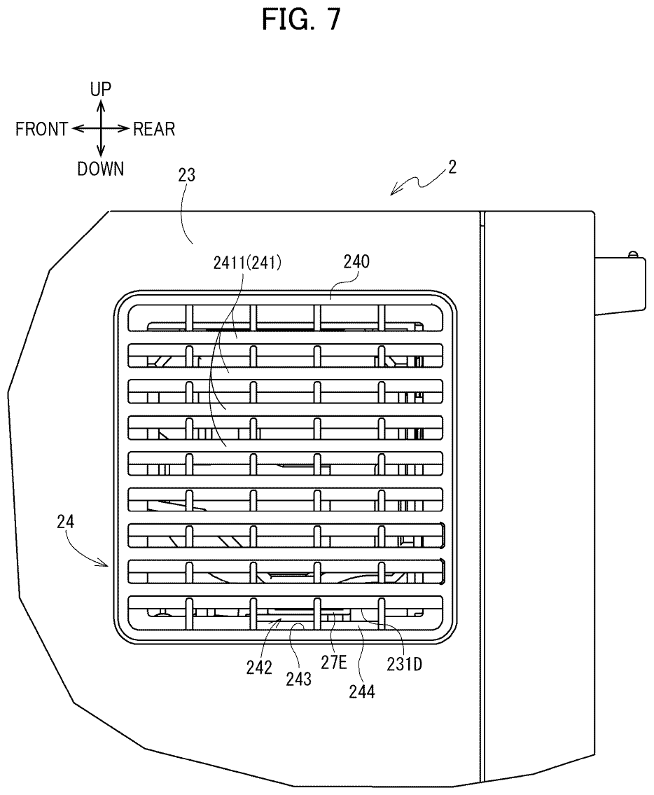

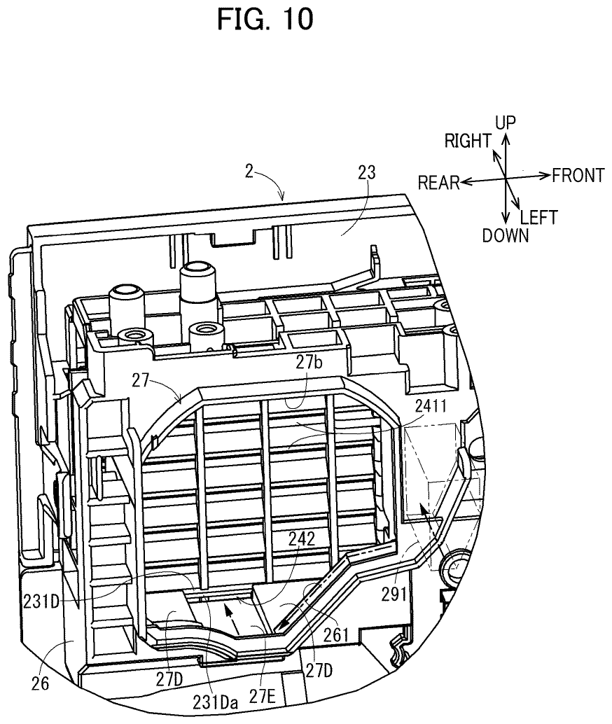

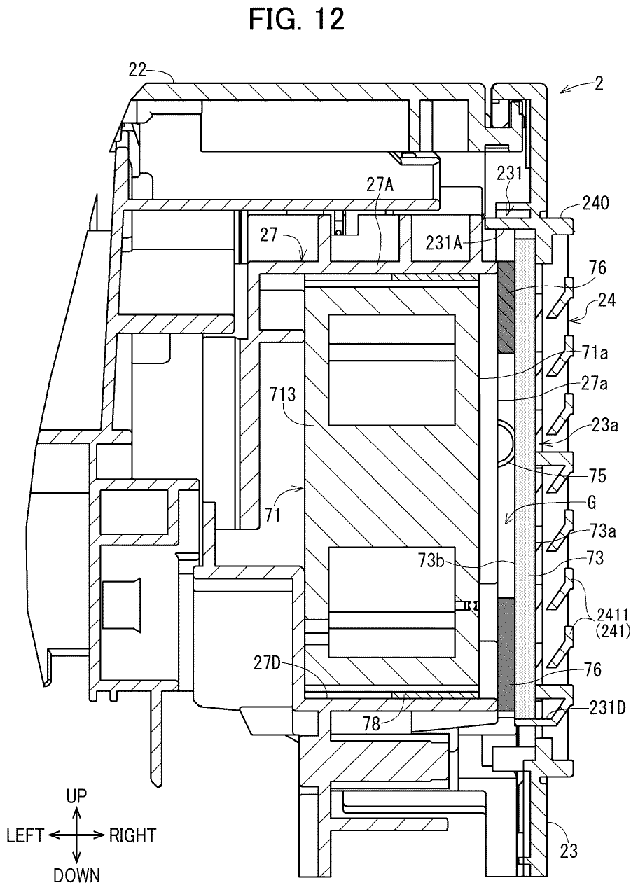

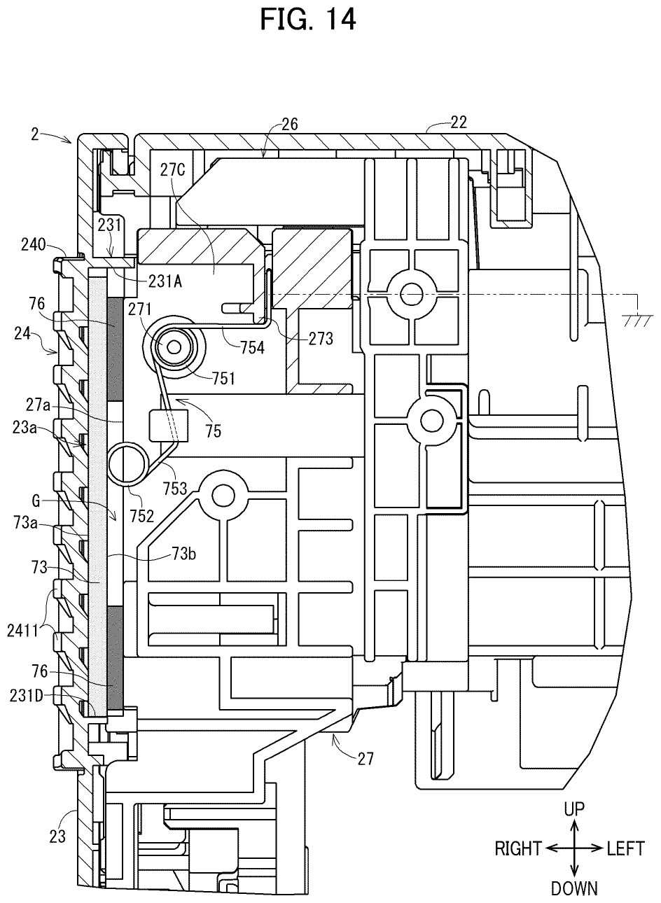

Hereinafter, one embodiment of the disclosure will be described with reference to FIGS. 1 through 16.

### [Image-Forming Apparatus 1]

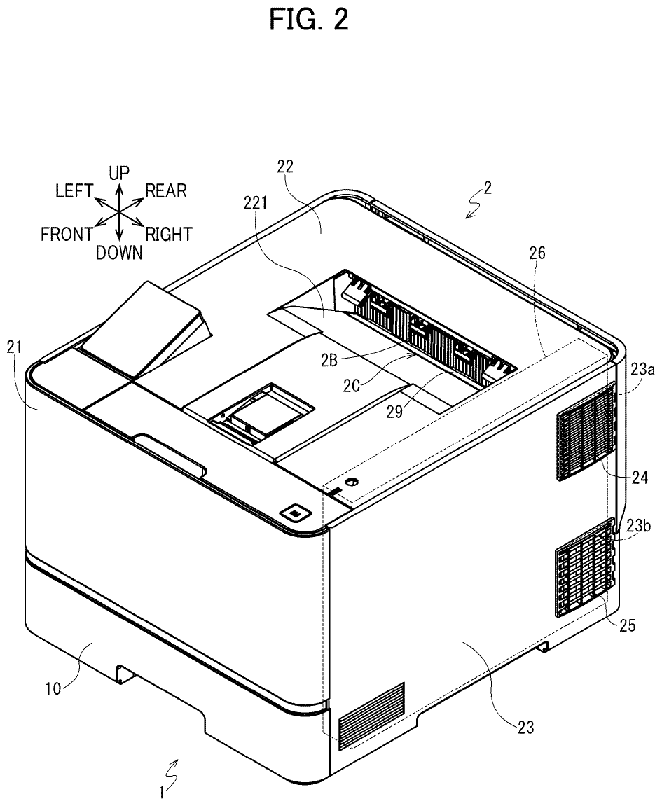

An image-forming apparatus 1 according to the one embodiment is illustrated in FIGS. 1 and 2. The image-forming apparatus 1 is an electrophotographic type color laser printer configured to form a multi-color image on a sheet S.

In the following description, the left side in FIG. 1 will be referred to as a front side of the image-forming apparatus 1, and the right side in FIG. 1 will be referred to as a rear side of the image-forming apparatus 1. Further, the near side in FIG. 1 will be referred to as a right side of the image-forming apparatus 1, and the far side in FIG. 1 will be referred to as a left side of the image-forming apparatus 1. Still further, the upper side and lower side in FIG. 1 will be referred to as an upper side and a lower side of the image-forming apparatus 1, respectively.

The image-forming apparatus 1 includes a housing 2, a sheet supply unit 3, and an image forming unit 5. The sheet supply unit 3 includes a sheet tray 10 configured to support the sheet S, and a sheet conveying unit 30 configured to convey the sheet S. The image forming unit 5 is configured to form an image on the sheet S conveyed by the sheet supply unit 3.

The housing 2 has a generally rectangular parallelepiped shape. The housing 2 accommodates therein the sheet supply unit 3 and the image forming unit 5. The housing 2 has a front surface on which a front opening 2A is open. The housing 2 includes a front cover 21 configured to open and close the front opening 2A.

The front cover 21 has a lower end portion where a pivot shaft 21a is provided. The front cover 21 is pivotally movable about an axis of the pivot shaft 21a between a closed position where the front cover 21 closes the front opening 2A and an open position where the front cover 21 opens the front opening 2A.

As illustrated in FIGS. 1 through 3, the housing 2 includes a top cover 22 providing an upper surface of the housing 2. The top cover 22 includes a discharge tray 221. The discharge tray 221 is sloped on the upper surface of the housing 2 such that the discharge tray 221 is inclined diagonally downward toward the rear.

The sheet supply unit 3 is positioned in a lower region of the housing 2. The sheet supply unit 3 is configured to convey the sheet S supported by the sheet tray 10 to the image forming unit 5 by the sheet conveying unit 30. The sheet tray 10 is slidably movable in the front-rear direction (rearward and frontward), relative to the housing 2, between an accommodated position where the sheet tray 10 is accommodated in the housing 2 and a separated position where the sheet tray 10 is pulled out frontward from the accommodated position.

The sheet conveying unit 30 includes a pick-up roller 32, a separation roller 33, a separation pad 33a, a pair of conveyer rollers 34, and a pair of registration rollers 35. A conveying path P is defined inside the housing 2. The conveying path P extends from the sheet tray 10 to the discharge tray 221 through the image forming unit 5.

The pick-up roller 32, the separation roller 33, and the separation pad 33a function to separate the sheets S supported on the sheet tray 10 one by one and convey the separated sheet S onto the conveying path P1. The pick-up roller 32 is configured to convey the sheet S from the sheet tray 10 toward the image forming unit 5. The separation roller 33 and the separation pad 33a constitute in combination a separator for separating the sheet S, one by one, from the remaining sheet(s) S supported on the sheet tray 10.

The sheet S delivered to the conveying path P is then conveyed toward the image forming unit 5 by the pair of conveyer rollers 34 and the pair of registration rollers 35. The pair of registration rollers 35 is configured to temporarily halt conveyance of the sheet S by regulating movement of a leading edge of each sheet S conveyed toward the image forming unit 5 from the sheet tray 10, and then convey the sheet S toward the image forming unit 5 at a prescribed timing.

The image forming unit 5 is positioned above the sheet supply unit 3. The image forming unit 5 includes four toner cartridges 50 juxtaposed in the front-rear direction, and four photosensitive drums 51 corresponding to the respective toner cartridges 50. The four toner cartridges 50 are provided respectively for the colors of yellow, magenta, cyan, and black. Each toner cartridge 50 includes a developing roller 52.

The toner cartridges 50 are attachable to and detachable from a drawer 59. The drawer 59 is configured to be attached to and detached from the housing 2 through the front opening 2A while the front cover 21 is opened. The drawer 59 is movable, relative to the housing 2, between a first position where the drawer 59 is accommodated inside the housing 2 and a second position where at least a part of the drawer 59 is located outside the housing 2.

Each photosensitive drum 51 has a generally hollow cylindrical shape whose axis extends in a left-right direction as an axial direction. The photosensitive drums 51 are rotatably supported by the drawer 59. Each developing roller 52 extends in the left-right direction, and is rotatably supported by a casing of the toner cartridge 50. The developing rollers 52 are configured to supply toner to the corresponding photosensitive drums 51.

The housing 2 accommodates therein an exposing device 56 configured to expose peripheral surfaces of the respective photosensitive drums 51 to light. The exposing device 56 includes a laser diode, a light beam deflector, lenses, mirrors, and the like. The exposing device 56 is configured to irradiate a light beam toward each photosensitive drum 51 to expose the peripheral surface of each photosensitive drum 51 to light.

A transfer belt 41 is positioned below the four photosensitive drums 51 to face the same such that the conveying path P1 is defined between the transfer belt 41 and each photosensitive drum 51. The transfer belt 41 is in contact with each of the photosensitive drums 51. The transfer belt 41 is an endless belt mounted under tension over a drive roller 42 and a follow roller 43 positioned frontward of the drive roller 42. In an internal space defined by the transfer belt 41, four transfer rollers 44 are arranged such that each transfer roller 44 faces the corresponding photosensitive drum 51 with the transfer belt 41 nipped therebetween. The transfer belt 41, the drive roller 42, the follow roller 43, and the transfer rollers 44 in combination constitute a belt unit 40 (see FIG. 1) of the image forming unit 5.

The image forming unit 5 also includes chargers 54 configured to charge the peripheral surfaces of the respective photosensitive drums 51. The chargers 54 are supported by the drawer 59. The photosensitive drums 51 uniformly charged by the corresponding chargers 54 are selectively exposed to light by the corresponding exposing devices 56. By this exposure to light, electric charge is selectively removed from the peripheral surface of each photosensitive drum 51 and an electrostatic latent image is formed on the peripheral surface of each photosensitive drum 51.

The toner stored in each toner cartridge 50 is charged to have a positive polarity, and is carried on a peripheral surface of the corresponding developing roller 52. A developing bias is applied to each developing roller 52, so that the toner is supplied from each developing roller 52 to the electrostatic latent image formed on the corresponding photosensitive drum 51 due to the difference in electric potential between the electrostatic latent image and the developing roller 52 when the electrostatic latent image faces the corresponding developing roller 52. In this way, a toner image is formed on the peripheral surface of each photosensitive drum 51.

Once the sheet S conveyed toward the image forming unit 5 reaches the transfer belt 41, the sheet S sequentially passes through positions defined between each photosensitive drum 51 and the transfer belt 41 while the sheet S is being conveyed by the transfer belt 41. The toner images carried on the peripheral surface of each photosensitive drum 51 is transferred to the sheet S by a transfer bias applied to each transfer roller 44 when each toner image faces the sheet S. In this way, the image forming unit 5 forms an image on the sheet S supplied from the sheet tray 10 by transferring the toner to the sheet S.

Incidentally, the transfer belt 41 according to the present embodiment is in a form of a conveyer belt configured to convey a sheet S to which a toner image is to be transferred. However, a transfer belt of the disclosure may be in a form of an intermediate transfer belt to which a toner image is to be transferred, and the transferred toner image on the belt is then transferred on a supplied sheet S.

After the toner image is transferred to the sheet S, the sheet S is conveyed to a fixing device 60. The fixing device 60 includes a heat roller 61 and a pressure roller 62 in pressure contact with the heat roller 61. In the fixing device 60, the toner image is thermally fixed to the sheet S while the sheet S passes through a position between the heat roller 61 and the pressure roller 62. That is, the fixing device 60 is configured to thermally fix the toner image to the sheet S.

The sheet S to which the toner image has been thermally fixed is conveyed toward downstream in a sheet conveying direction from the fixing device 60, and is then conveyed further downstream by a pair of intermediate discharge rollers 63 and a pair of discharge rollers 64 positioned downstream of the intermediate discharge rollers 63 in the sheet conveying direction, and is finally discharged onto the discharge tray 221.

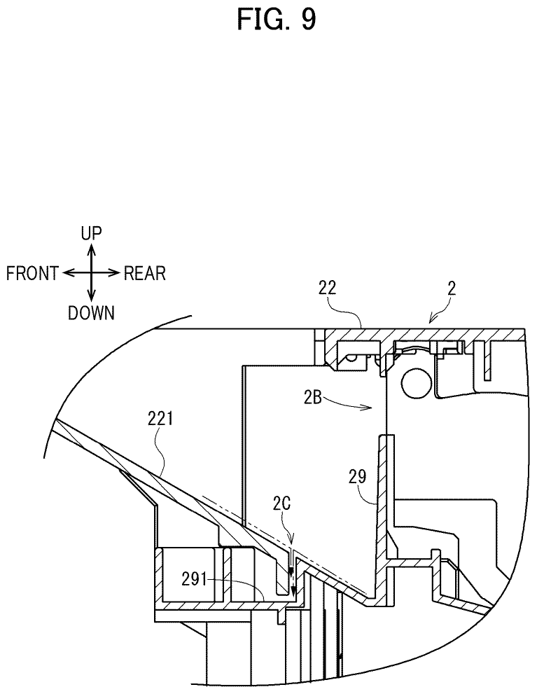

As illustrated in FIGS. 1 through 3, the top cover 22 of the housing 2 further includes a discharge frame 29. The discharge frame 29 is positioned rearward of the discharge tray 221. The discharge frame 29 has a discharge opening 2B elongated in the left-right direction. The discharge opening 2B penetrates the discharge frame 29 in the front-rear direction (see FIG. 9). The sheet S conveyed by the pair of discharge rollers 64 is discharged onto the discharge tray 221 through the discharge opening 2B.

In the image-forming apparatus 1, the drawer 59, the toner cartridges 50 supported by the drawer 59, the photosensitive drums 51, the chargers 54, and the like constitute in combination a process unit PU (see FIG. 1) configured to form a toner image on each sheet S.

Incidentally, the process unit PU may at least include the photosensitive drums 51 and the chargers 54, or may further include the transfer belt 41 or the fixing device 60. Further, in the process unit PU, the photosensitive drums 51 may be supported by the drawer 59 as in the present embodiment, or may be supported by the respective toner cartridges 50.

The image-forming apparatus 1 also includes a power circuit board 11 forming a power supply circuit, and a circuit board cover 12 covering the power circuit board 11. The circuit board cover 12 is positioned between the sheet tray 10 and the belt unit 40 in a rear internal portion of the housing 2. The process unit PU and the circuit board cover 12 are accommodated in the housing 2.

The image-forming apparatus 1 further includes a first fan 71 and a second fan 72 for discharging air inside the housing 2 to the outside of the housing 2. In the housing 2, the first fan 71 is positioned rightward and rearward of the process unit PU. The first fan 71 is configured to discharge the air, which has flown through the process unit PU, to the outside of the housing 2. Hence, the air that has flown through the process unit PU in the housing 2 can be effectively discharged to the outside of the housing 2 by the first fan 71. The housing 2 is an example of “housing” of the disclosure.

The second fan 72 is positioned rightward of the circuit board cover 12 in the housing 2. Specifically, the second fan 72 is arranged at such a position that, when the second fan 72 is projected onto the circuit board cover 12 in the left-right direction, a plane of projection of the second fan 72 overlaps with a rear portion of the circuit board cover 12. The second fan 72 is configured to discharge the air inside the circuit board cover 12 to the outside of the housing 2. The second fan 72 is positioned below the first fan 71 in the housing 2.

As illustrated in FIG. 2, a right frame 26 is accommodated in an internal right end portion of the housing 2. The housing 2 also includes a right side wall 23 covering the right frame 26 from its right side. The right side wall 23 has a first opening 23a and a second opening 23b penetrating the right side wall 23 in the left-right direction. The first opening 23a and the second opening 23b are positioned in a rear end portion of the right side wall 23. The first opening 23a is positioned above the second opening 23b.

The first fan 71 is supported by the right frame 26. The first fan 71 is arranged at such a position that, when the first fan 71 is projected onto the right side wall 23 in the left-right direction, a plane of projection of the first fan 71 overlaps with the first opening 23a. When driven, the first fan 71 is configured to generate air stream flowing toward the right, thereby allowing the air in the process unit PU to flow rightward by the generated air stream to be discharged to the outside of the housing 2 through the first opening 23a.

Hereinafter, the direction in which the first fan 71 is configured to discharge air will be referred to as a first discharging direction. In the present embodiment, the first discharging direction is coincident with a rightward direction. The right side wall 23 is positioned rightward of the first fan 71, i.e., downstream of the first fan 71 in the first discharging direction. The first fan 71 is an example of “fan” of the disclosure. The first discharging direction is an example of “discharging direction” of the disclosure.

The second fan 72 is supported by the right frame 26. The second fan 72 is at such a position that, when the second opening 23b is projected onto the right side wall 23 in the left-right direction, a plane of projection of the second fan 72 overlaps with the second opening 23b. When driven, the second fan 72 is configured to generate air stream flowing toward the right, thereby allowing the air in the circuit board cover 12 to flow rightward by the generated air stream to be discharged to the outside of the housing 2 through the second opening 23b.

Hereinafter, the direction in which the second fan 72 is configured to discharge air will be referred to as a second discharging direction. In the present embodiment, the second discharging direction is coincident with the rightward direction. The right side wall 23 is positioned rightward of the second fan 72, i.e., downstream of the second fan 72 in the second discharging direction. The second fan 72 is another example of the “fan” of the disclosure. The second discharging direction is another example of the “discharging direction” of the disclosure.

### [First Fan 71, First Duct 27, First Discharge Filter 73, and First Louver 24]

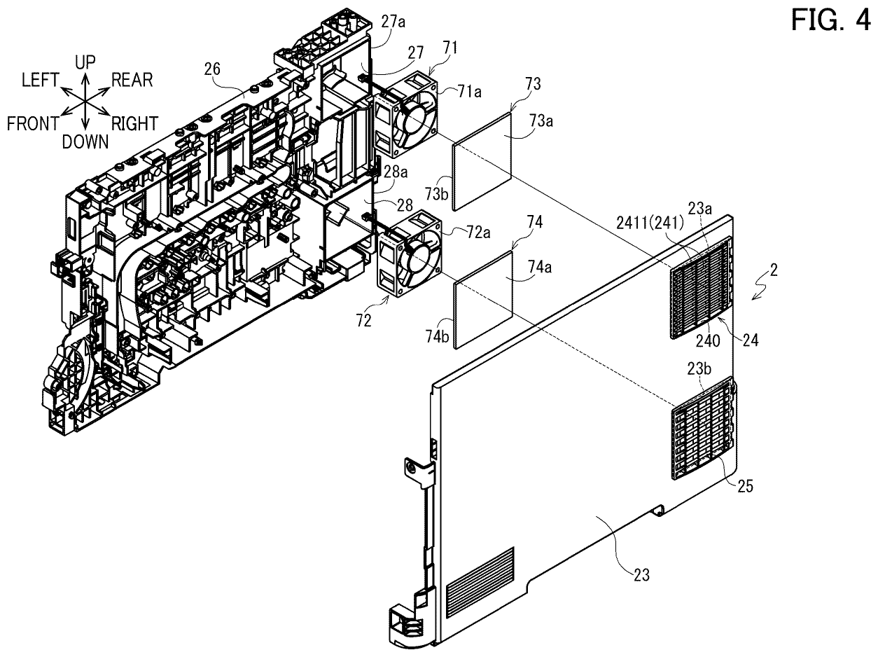

As illustrated in FIGS. 4 through 6, the right frame 26 has a first duct 27 penetrating the right frame 26 in the left-right direction. The first duct 27 extends in the first discharging direction, and is configured to allow air to flow therethrough in the first discharging direction.

The first duct 27 has a rectangular cross-section taken along a plane perpendicular to the first discharging direction. That is, the first duct 27 has a rectangular shape as viewed in the left-right direction. The first fan 71 is fittingly inserted in the first duct 27. The first duct 27 accommodates the first fan 71 therein. The first duct 27 is an example of “duct” of the disclosure.

The first fan 71 has a first downstream end 71a in the first discharging direction. The first duct 27 has a second downstream end 27a in the first discharging direction. In the present embodiment, the second downstream end 27a of the first duct 27 is positioned further downstream relative to the first downstream end 71a of the first fan 71 in the first discharging direction. That is, the second downstream end 27a protrudes further rightward relative to the first downstream end 71a in the first discharging direction.

However, the first downstream end 71a of the first fan 71 may protrude further downstream (rightward) of the second downstream end 27a of the first duct 27 in the first discharging direction. Alternatively, the first downstream end 71a of the first fan 71 and the second downstream end 27a of the first duct 27 may be at the same position as each other (aligned with each other) in the first discharging direction.

A first louver 24 is provided on the right side wall 23 of the housing 2. The first louver 24 covers the first opening 23a of the right side wall 23 and provides communication between an interior and an exterior of the housing 2. In the present embodiment, the first louver 24 is integrally molded with the right side wall 23. Alternatively, the first louver 24 may be attachable to and detachable from the right side wall 23.

The first louver 24 is positioned rightward of the first fan 71. That is, the first louver 24 is positioned downstream of the first fan 71 in the first discharging direction. In other words, the first fan 71 is positioned upstream of the first louver 24 in the first discharging direction. The first louver 24 protrudes rightward from an outer surface of the right side wall 23.

As illustrated in FIGS. 4 through 7, the first louver 24 formed in the right side wall 23 includes a frame part 240, and a lattice part 241. The frame part 240 has a rectangular shape and extends in conformance with the periphery of the first opening 23a to surround the same. The frame part 240 protrudes rightward from the outer surface of the right side wall 23.

The lattice part 241 is enclosed by the frame part 240. The lattice part 241 is configured of a plurality of crosspieces 2411 each extending in the front-rear direction. The crosspieces 2411 are arrayed at intervals in an up-down direction. Each crosspiece 2411 is so shaped that a lower portion thereof is sloped to extend diagonally upward toward the right. With this structure, while the air flows through the first louver 24, the air stream moving toward the right changes its moving direction toward diagonally upward and rightward.

The first louver 24 has a lower end portion where an opening 242 is formed. The opening 242 is a through-hole penetrating the lower end portion of the first louver 24 in the left-right direction. The opening 242 provides communication between the interior and the exterior of the housing 2.

The image-forming apparatus 1 further includes a first discharge filter 73. The first discharge filter 73 is positioned between the first fan 71 and the first louver 24 in the first discharging direction. The first discharge filter 73 is an example of “filter” of the disclosure. The first discharge filter 73 has a rectangular shape as viewed in the left-right direction. The first discharge filter 73 has a first surface 73a facing rightward, and a second surface 73b facing leftward.

The first discharge filter 73 is a honeycomb filter having a honeycomb structure formed of a filter material. The honeycomb filter as the first discharge filter 73 contains multiple cells defined by partition walls extending in the first discharging direction.

The honeycomb filter as the first discharge filter 73 may be configured by, for example, a sheet of paper carrying activated charcoal or ozone decomposing catalyst such as manganese dioxide, a metal such as aluminum, and ceramics. The first discharge filter 73 has a rectangular sheet-like shape.

Within the housing 2, ozone is to be generated from parts configured to generate electric discharge in the air, such as the chargers 54 in the process unit PU. Further, the toner stored in the toner cartridges 50 is likely to float in the interior of the housing 2.

By the suction of the first fan 71, the air inside the process unit PU is urged to flow toward the rear and then toward the right, and finally passes through the first discharge filter 73. Ozone and particles such as toner are to be trapped in the first discharge filter 73 while the air passes through the first discharge filter 73, and the cleaned air (from which the ozone and particles have been removed) is to be discharged to the outside of the housing 2 through the first louver 24. Accordingly, the ozone and particles are less likely to remain in the air that is discharged through the first discharge filter 73 after flowing through the process unit PU.

Incidentally, the first discharge filter 73 may be a filter of any type as long as the filter can remove at least minute particles such as toner from the air. The first discharge filter 73 may be a filter that can not only remove the minute particles but also ozone from the air. By employing, as the first discharge filter 73, a filter capable of removing ozone from the air discharged by the first fan 71, the amount of ozone to be contained in the air discharged by the first fan 71 can be reduced.

The housing 2 also includes an accommodation wall 231 protruding leftward from the right side wall 23. That is, the accommodation wall 231 protrudes toward upstream in the first discharging direction from an inner surface of the right side wall 23. The accommodation wall 231 has a rectangular frame-like shape as viewed in the left-right direction. The first discharge filter 73 is accommodated on the inside of the accommodation wall 231. The accommodation wall 231 surrounds an entire outer periphery of the first discharge filter 73.

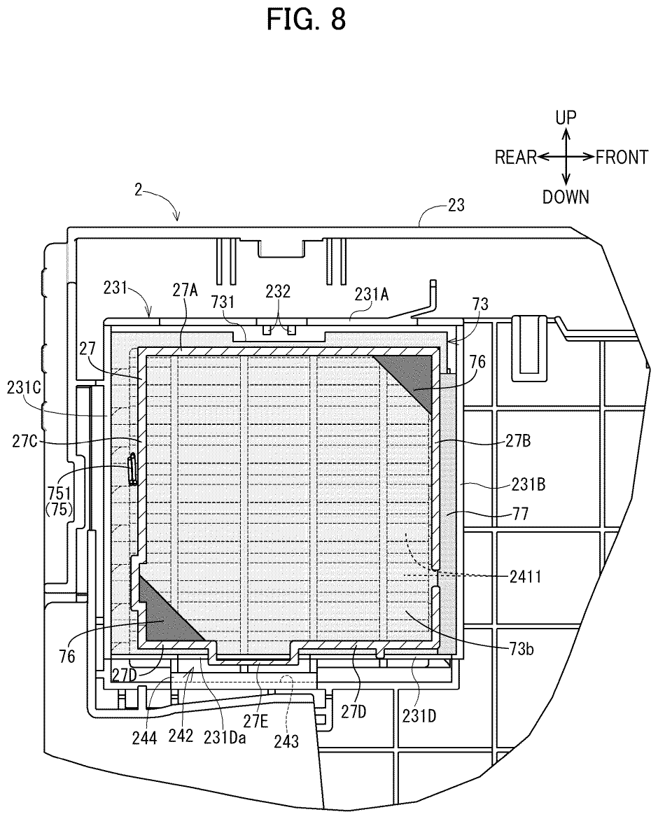

As illustrated in FIG. 8, the accommodation wall 231 includes an upper wall part 231A, a front wall part 231B, a rear wall part 231C, and a lower wall part 231D. The upper wall part 231A is positioned above the first discharge filter 73. The front wall part 231B is positioned frontward of the first discharge filter 73. The rear wall part 231C is positioned rearward of the first discharge filter 73. The lower wall part 231D is positioned below the first discharge filter 73. The lower wall part 231D supports a lower end of the first discharge filter 73 accommodated in the accommodation wall 231.

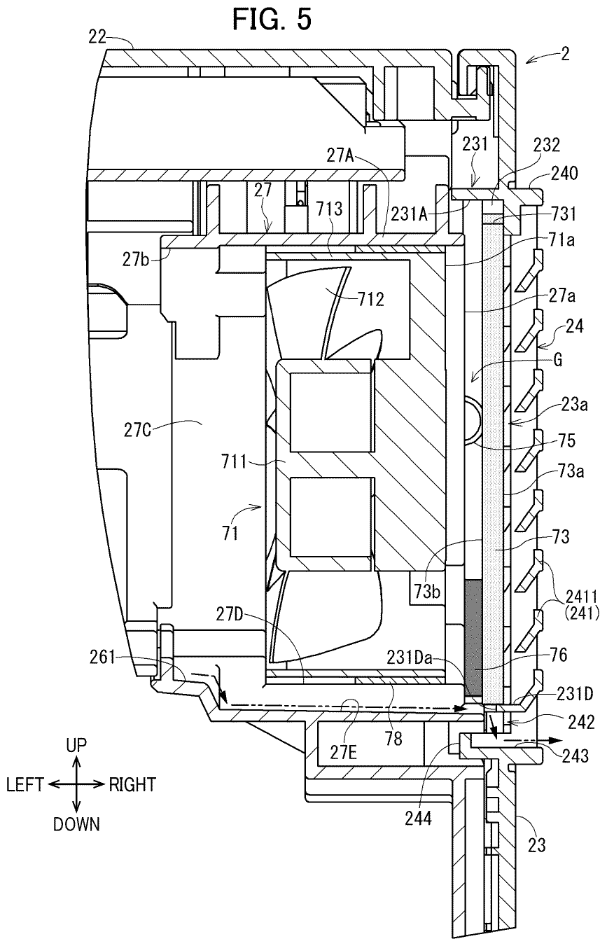

As illustrated in FIGS. 5, 6 and 13, the first fan 71 includes a rotation shaft 711 extending in the left-right direction, an impeller 712 fixed to the rotation shaft 711, and a case 713 rotatably supporting the rotation shaft 711. That is, the first fan 71 is an axial flow fan configured to deliver air in an axial direction of the rotation shaft 711. The case 713 of the first fan 71 has a rectangular outer shape. The outer shape of the case 713 defines an outer shape of the first fan 71.

The first duct 27 has an open end 27b which is an upstream end of the first duct 27 in the first discharging direction. The air inside the housing 2 is introduced into the first duct 27 through the open end 27b. second downstream end 27a

As illustrated in FIGS. 5, 6, and 8, the first duct 27 includes a duct upper wall part 27A positioned above the first fan 71, a duct front wall part 27B positioned frontward of the first fan 71, a duct rear wall part 27C positioned rearward of the first fan 71, a duct lower wall part 27D positioned below the first fan 71, and a duct bottom wall part 27E positioned below the first fan 71.

The duct upper wall part 27A, duct front wall part 27B, duct rear wall part 27C, and the duct lower wall part 27D in combination constitute a peripheral wall of the first duct 27. The duct upper wall part 27A, duct front wall part 27B, duct rear wall part 27C, and duct lower wall part 27D in combination support the first fan 71 accommodated in the first duct 27. The peripheral wall of the first duct 27 surrounds the outer periphery of the first fan 71. The second downstream end 27a of the first duct 27 is a downstream end of the peripheral wall of the first duct 27 in the first discharging direction.

The duct bottom wall part 27E is positioned at a midway region of the duct lower wall part 27D in the front-rear direction. The duct bottom wall part 27E is recessed downward from the duct lower wall part 27D. The duct lower wall part 27D is positioned above the lower wall part 231D of the accommodation wall 231, whereas the duct bottom wall part 27E is positioned below the lower wall part 231D of the accommodation wall 231.

A gap G is provided between the peripheral wall of the first duct 27 and the first discharge filter 73 in the left-right direction. Two first elastic members 76 are provided in this gap G.

### [Buffer 78 Between First Fan 71 and First Duct 27]

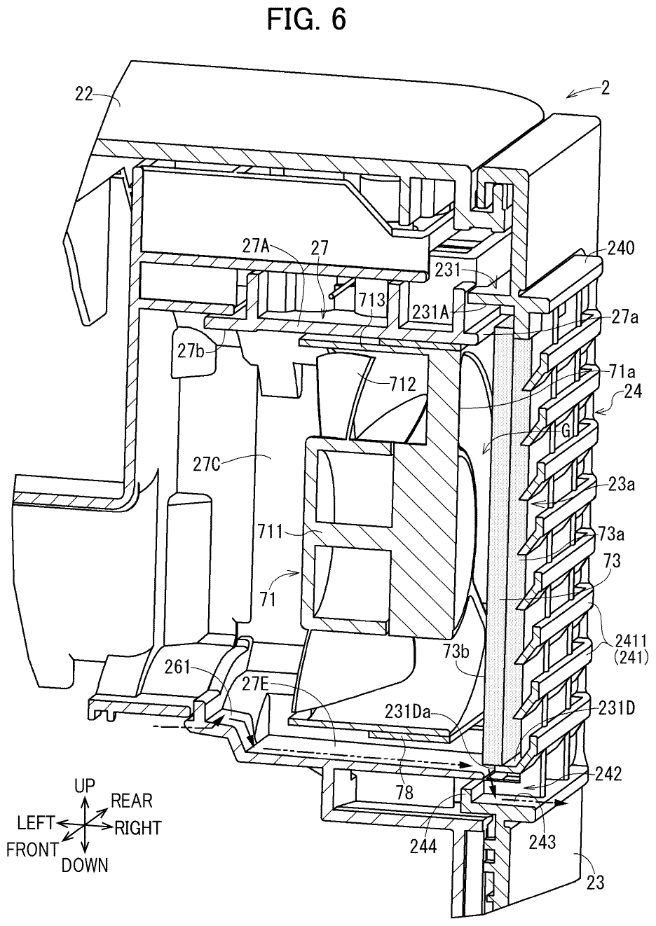

As illustrated in FIGS. 5 and 6, a buffer 78 is interposed between an outer peripheral surface of the case 713 of the first fan 71 and an inner peripheral surface of the first duct 27. The buffer 78 closes a gap formed between the case 713 of the first fan 71 and the first duct 27. The buffer 78 is formed of a member having elasticity. For example, the buffer 78 is configured as a sponge having elasticity.

Since the buffer 78 is disposed in the gap between the outer peripheral surface of the first fan 71 and the inner peripheral surface of the first duct 27 to fill the gap, the air delivered by the first fan 71 can be restrained from being leaked through the gap between the first fan 71 and the first duct 27.

### [Liquid Flow Channel]

As illustrated in FIGS. 2, 3 and 9, a slit 2C is formed between the discharge tray 221 and the discharge frame 29 of the housing 2. The slit 2C extends in the left-right direction and in the up-down direction to provide communication between the interior and the exterior of the housing 2. A drain channel 291 is provided in the discharge frame 29 at a position below the slit 2C. The drain channel 291 extends toward the right from a position below the slit 2C.

For example, in a case where liquid such as water is splashed onto the discharge tray 221 or the discharge frame 29, the liquid falls downward through the slit 2C, and enters the interior of the housing 2. The liquid then falls onto the drain channel 291, and flows rightward along the drain channel 291.

As illustrated in FIGS. 5, 6, and 10, the right frame 26 includes a frame channel 261 configured to allow liquid to flow therealong. The frame channel 261 is positioned below and frontward of the open end 27b of the first duct 27. The frame channel 261 extends generally in the up-down direction, and is sloped to extend diagonally rearward and downward. The frame channel 261 has a front end connected to a right end of the drain channel 291.

The frame channel 261 has a lower end connected to the duct bottom wall part 27E of the first duct 27. The duct bottom wall part 27E extends in the left-right direction and positioned below the first fan 71. Specifically, in the first discharging direction, the duct bottom wall part 27E extends to cover the first fan 71 as a whole from below, i.e., from a position upstream of the first fan 71 to a position downstream of the first fan 71. The duct bottom wall part 27E of the first duct 27 is positioned below the lower end of the first discharge filter 73. In other words, the lower end of the first discharge filter 73 is positioned above the upper surface of the duct bottom wall part 27E.

As illustrated in FIGS. 5, 6, 8 and 11, the right side wall 23 of the housing 2 further includes a housing bottom wall 243. The housing bottom wall 243 is positioned below the lower wall part 231D of the accommodation wall 231. Further, the housing bottom wall 243 is positioned below the lower end of the first discharge filter 73. The housing bottom wall 243 extends in the left-right direction from a position inward (leftward) of the right side wall 23 to a position outward (rightward) of the right side wall 23.

The opening 242 of the first louver 24 is positioned between the lower wall part 231D of the accommodation wall 231 and the housing bottom wall 243. Specifically, the lower wall part 231D defines an upper edge of the opening 242, and the housing bottom wall 243 defines a lower edge of the opening 242. The opening 242 is positioned between the lower end of the first discharge filter 73 and the housing bottom wall 243.

The upper surface of the housing bottom wall 243 is positioned below the upper surface of the duct bottom wall part 27E. In the first discharging direction, the downstream end of the duct bottom wall part 27E is positioned further downstream relative to an upstream end of the housing bottom wall 243. The duct bottom wall part 27E and the housing bottom wall 243 are overlapped with each other as viewed in the up-down direction.

In the first discharging direction, the downstream end of the duct bottom wall part 27E is positioned further downstream relative to the second downstream end 27a of the first duct 27 (downstream end of the peripheral wall of the first duct 27 defined by the duct upper wall part 27A, duct front wall part 27B, duct rear wall part 27C and duct lower wall part 27D).

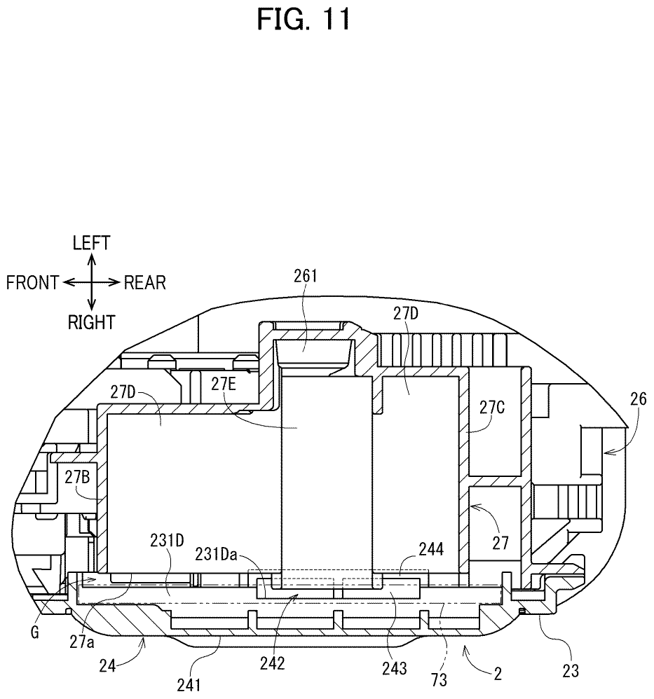

The lower wall part 231D of the accommodation wall 231 has a notch 231Da at a position facing the duct bottom wall part 27E. In the first discharging direction, a downstream end of the notch 231Da is positioned further downstream than the downstream end of the duct bottom wall part 27E, as illustrated in FIG. 11. On the upstream end (left end) of the lower wall part 231D, a first part (where the notch 231Da is formed) is positioned further downstream than a second part (where the notch 231Da is not formed) in the first discharging direction.

The housing 2 also includes a side wall 244 protruding upward from the upstream end of the housing bottom wall 243 in the first discharging direction. The downstream end of the duct bottom wall part 27E is positioned further downstream relative to the side wall 244 in the first discharging direction.

The liquid flowing along the drain channel 291 is dropped down from the right end of the drain channel 291 onto the frame channel 261, and then flows along the frame channel 261. The liquid flowing through the frame channel 261 then flows onto the duct bottom wall part 27E, and is subsequently transferred therefrom onto the housing bottom wall 243. The liquid flowing along the housing bottom wall 243 is finally discharged to the outside of the housing 2 through the opening 242 of the first louver 24.

In this way, a liquid flow channel is provided by the frame channel 261 and the duct bottom wall part 27E in the right frame 26. As such, in a case where liquid splashed onto the top cover 22 and the like flows to the first duct 27 of the right frame 26, the liquid is allowed to flow along the frame channel 261 and the duct bottom wall part 27E. Further, due to the provision of the housing bottom wall 243 and the opening 242, the liquid flowing through the frame channel 261 and the duct bottom wall part 27E can be guided along the housing bottom wall 243 and discharged to the outside of the housing 2 through the opening 242.

Accordingly, the liquid having entered the housing 2 and reached the housing bottom wall 243 can be smoothly discharged to the outside of the housing 2 through the opening 242 without passing through the first discharge filter 73.

In this case, since the upper surface of the housing bottom wall 243 is positioned below the upper surface of the duct bottom wall part 27E, the liquid flowing along the duct bottom wall part 27E can be smoothly transferred from the duct bottom wall part 27E to the housing bottom wall 243.

Further, in the first discharging direction, the downstream end of the duct bottom wall part 27E is positioned further downstream than the upstream end (left end) of the housing bottom wall 243. With this structure, the liquid falling down from the downstream end (right end) of the duct bottom wall part 27E is reliably dropped onto the upper surface of the housing bottom wall 243. Hence, the liquid flowing through the duct bottom wall part 27E can be fully transferred onto the housing bottom wall 243.

Further, in the first discharging direction, the downstream end (right end) of the duct bottom wall part 27E protrudes further downstream than the second downstream end 27a of the first duct 27 which is defined by downstream ends of the duct upper wall part 27A, duct front wall part 27B, duct rear wall part 27C, and duct lower wall part 27D constituting the peripheral wall of the first duct 27. With this structure, the downstream end (right end) of the duct bottom wall part 27E can be arranged further downstream (rightward) than the upstream end (left end) of the housing bottom wall 243, while the gap G can be maintained between the peripheral wall of the first duct 27 and the first discharge filter 73 for positioning the first elastic members 76 in the gap G.

Further, the housing 2 includes the side wall 244 protruding upward from the upstream end (left end) of the housing bottom wall 243 in the first discharging direction. With this structure, the side wall 244 can suppress the liquid flowing along the housing bottom wall 243 from flowing back into the interior of the housing 2.

Further, the lower end of the first discharge filter 73 is positioned above the upper surface of the duct bottom wall part 27E, thereby reliably preventing the liquid flowing along the duct bottom wall part 27E from touching the first discharge filter 73. Hence, the first discharge filter 7 does not interrupt the flow of the liquid. Further, since the first discharge filter 73 does not become wet by the liquid, the first discharge filter 73 can maintain its inherent function to remove the ozone and particles in the air discharged by the rotation of the first fan 71.

Further, the lower wall part 231D of the accommodation wall 231 has the notch 231Da whose downstream end in the first discharging direction is positioned further downstream in the first discharging direction than the downstream end (right end) of the duct bottom wall part 27E. With this structure, the liquid flowing along the duct bottom wall part 27E is less likely to contact the lower wall part 231D. Hence, the lower wall part 231D does not hinder the flow of the liquid flowing along the duct bottom wall part 27E.

### [First Elastic Members 76]

As illustrated in FIGS. 5, 6 and 12, the gap G is defined between the first discharge filter 73 and the first duct 27, in other words, between the first discharge filter 73 and the first fan 71 in the first discharging direction. The two first elastic members 76 are positioned in the gap G between the first discharge filter 73 and the first duct 27 in the first discharging direction. The first elastic members 76 are made of an elastic material. For example, the first elastic members 76 are formed of sponge having elasticity.

The gap G is filled by the first elastic members 76 interposed between the first discharge filter 73 and the first duct 27 at regions where the respective first elastic members 76 are located. Each first elastic member 76 is in contact with the second downstream end 27a of the first duct 27 and the second surface 73b of the first discharge filter 73. Each first elastic member 76 is not in contact with the first downstream end 71a of the first fan 71.

However, as a modification, in a configuration where the first downstream end 71a of the first fan 71 is positioned further downstream of the second downstream end 27a of the first duct 27 in the first discharging direction, each first elastic member 76 may not contact the second downstream end 27a of the first duct 27 but may be in contact with the first downstream end 71a of the first fan 71.

Alternatively, as a further modification, in a configuration where the first downstream end 71a of the first fan 71 and the second downstream end 27a of the first duct 27 are arranged at the same position as each other (aligned with each other) in the first discharging direction, each first elastic member 76 may be in contact with both the first downstream end 71a of the first fan 71 and the second downstream end 27a of the first duct 27.

That is, each first elastic member 76 is positioned between the first duct 27 and the first discharge filter 73 and between the first fan 71 and the first discharge filter 73 (i.e., between the first discharge filter 73 and each of the first fan 71 and first duct 27) in the first discharging direction, and is in contact with the first discharge filter 73 and at least one of the first downstream end 71a of the first fan 71 and the second downstream end 27a of the first duct 27. The first elastic member 76 is an example of “first elastic member” of the disclosure.

Since the first elastic members 76 are in contact with the second surface 73b of the first discharge filter 73 accommodated in the accommodation wall 231, the first elastic members 76 urge the first discharge filter 73 toward downstream in the first discharging direction. Accordingly, even in a case where an external force is applied to the right side wall 23 toward upstream in the first discharging direction (in a direction opposite the first discharging direction), the first elastic members 76 can restrain the first discharge filter 73 from being displaced toward upstream in the first discharging direction (in the direction opposite the first discharging direction), thereby suppressing the first discharge filter 73 from coming off the accommodation wall 231.

In a case where an external force is applied to the right side wall 23, the first discharge filter 73 is urged by the right side wall 23 to move toward upstream in the first discharging direction, i.e., in a direction to approach the first duct 27 and the first fan 71.

However, in the image-forming apparatus 1 according to the embodiment, since the first elastic members 76 are positioned between the first duct 27 and the first discharge filter 73, pressure force to be applied from the first duct 27 toward the first discharge filter 73 can be absorbed by the first elastic members 76. Hence, the ozone decomposing catalyst and particles such as activated charcoal trapped in the first discharge filter 73 are less likely to be scattered from the first discharge filter 73.

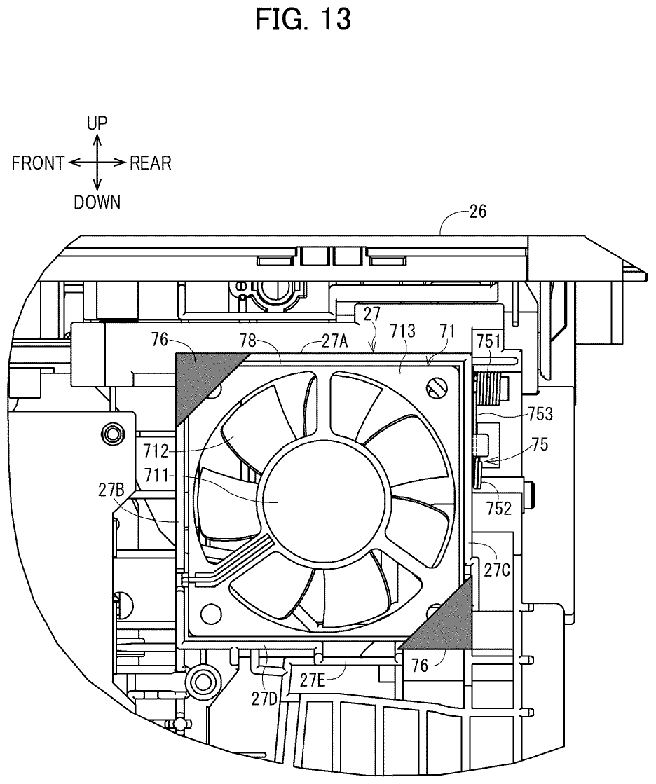

As illustrated in FIG. 13, the two first elastic members 76 are provided at two diagonally opposing corners of the rectangular first duct 27. Specifically, one of the first elastic members 76 is positioned at an upper-front corner defined by the duct upper wall 27A and the duct front wall 27B, and a remaining one of first elastic members 76 is positioned at a lower-rear corner defined by the duct lower wall part 27D and the duct rear wall part 27C.

Each first elastic member 76 is in a triangular shape, such as a right-angled triangular shape. Each first elastic member 76 is arranged such that a right-angled apex thereof is in alignment with the corresponding corner of the first duct 27.

By arranging the first elastic members 76 only at two diagonally opposing corners of the rectangular first duct 27, displacement of the first discharge filter 73 as well as scattering of the particles from the first discharge filter 73 can be restrained with a minimum region of the first discharge filter 73 covered by the first elastic members 76.

Further, since the first elastic members 76 are formed of sponge, the first elastic members 76 can stably depress the first discharge filter 73 using the elastic force of the sponge. As such, scattering of the particles from the first elastic member 76 can be further suppressed, while displacement of the first discharge filter 73 is restricted.

Further, the first elastic members 76 are positioned offset from the duct bottom wall part 27E in the front-rear direction which is a horizontal direction perpendicular to the first discharging direction. That is, with respect to the position in the front-rear direction, each first elastic member 76 and the duct bottom wall part 27E do not overlap each other. Further, the first elastic members 76 are positioned higher than the duct bottom wall part 27E.

Hence, the first elastic members 76 are less likely to get wet by the liquid flowing along the duct bottom wall part 27E, and the pressing force of the first elastic members 76 applied to the first discharge filter 73 is less likely to be degraded.

Incidentally, the first elastic members 76 may be adhered to the first discharge filter 73, rather than to the first duct 27. In this case, the first elastic members 76 may be adhesively bonded to the first discharge filter 73 in advance before the first discharge filter 73 is accommodated into the accommodation wall 231. With this structure, the first elastic members 76 can be positioned between the first discharge filter 73 and the first duct 27 (between the first discharge filter 73 and the first fan 71) only through a simply task of accommodating the first discharge filter 73 into the accommodation wall 231.

### [Ground Spring 75]

As illustrated in FIGS. 8, 13, and 14, the image-forming apparatus 1 includes a ground spring 75 that is grounded. The ground spring 75 is supported by the duct rear wall part 27C. The ground spring 75 is a coil spring formed by winding a wire having electrical conductivity and resiliency.

The ground spring 75 includes a first coil part 751, a second coil part 752, a first arm part 753, and a second arm part 754. The first coil part 751 and the second coil part 752 are formed into a hollow cylindrical shape by winding the wire. The first arm part 753 extends from the first coil part 751, and connects the first coil part 751 to the second coil part 752. The second arm part 754 extends from the first coil part 751, and is a part different from the first arm part 753. That is, the second arm part 754 and first arm part 753 respectively extend from the first coil part 751 in different directions from each other.

A boss 271 protrudes rearward from the duct rear wall part 27C of the first duct 27. The first coil part 751 of the ground spring 75 is rotatably supported by the boss 271.

The first arm part 753 extends diagonally downward and leftward from the first coil part 751, and is then bent diagonally downward and rightward. The first arm part 753 has a tip end connected to the second coil part 752.

The second arm part 754 extends leftward from the first coil part 751, and is then bent upward. The second arm part 754 is grounded. Specifically, for grounding, the second arm part 754 is connected to a metal frame having electrical conductivity.

Further, a protrusion 273 is provided on the duct rear wall part 27C of the first duct 27 to protrude rearward therefrom. The second arm part 754 of the ground spring 75 is engaged with the protrusion 273 from below.

With this configuration, the ground spring 75 provides an urging force acting in a direction for moving the second coil part 752 rightward. The second coil part 752 is in contact with the second surface 73b of the first discharge filter 73 due to the urging force of the ground spring 75. The second coil part 752 is thus stably pressed against the first discharge filter 73 by the urging force of the ground spring 75, thereby securely pressing the first discharge filter 73 rightward, i.e., toward downstream in the first discharging direction.

The first discharge filter 73 is grounded through contact of the second coil part 752 with the second surface 73b of the first discharge filter 73. The ground spring 75 is an example of “grounding member” of the disclosure. The grounding of the first discharge filter 73 through the ground spring 75 can suppress stagnation of static electricity in the first discharge filter 73, thereby avoiding electric discharge from the first discharge filter 73 toward neighboring components such as the first fan 71.

Further, as illustrated in FIG. 8, the second coil part 752 is in contact with the second surface 73b of the first discharge filter 73 at a position outside of a region enclosed by the peripheral wall of the first duct 27, i.e., the region surrounded by the duct upper wall part 27A, the duct front wall part 27B, the duct rear wall part 27C, and the duct lower wall part 27D.

As described above, since the ground spring 75 presses the first discharge filter 73 toward downstream in the first discharging direction, the first discharge filter 73 can be restricted from being displaced relative to the accommodation wall 231 and being detached from the accommodation wall 231 even when an external force (leftward direction) is applied to the housing 2 (right side wall 23).

Further, since the ground spring 75 has resiliency, the first discharge filter 73 is less likely to be pressed excessively by the ground spring 75 even if an external force is applied to the housing 2 (right side wall 23). Hence, the particles trapped in the first discharge filter 73 are less likely to be released from the first discharge filter 73.

In the present embodiment, the ground spring 75 is supported by the duct rear wall part 27C of the first duct 27. Alternatively, the ground spring 75 may be supported by the duct upper wall part 27A, the duct front wall part 27B, or the duct lower wall part 27D.

Further, in the present embodiment, the ground spring 75 is a coil spring including the first coil part 751, the second coil part 752, the first arm part 753, and the second arm part 754. However, the configuration of the ground spring 75 need not be limited to that of the embodiment, but may be configured in various shapes as long as the ground spring 75 is electrically conductive and resiliently deformable.

### [Notch 731 of the First Discharge Filter 73 and Protrusions 232 of Right Side Wall 23]

As illustrated in FIGS. 8, 15, and 16, the first discharge filter 73 has a notch 731. The notch 731 is formed on an upper side of the rectangular-shaped first discharge filter 73. Specifically, the notch 731 is notched downward from a generally center region on the upper side of the rectangle of the first discharge filter 73.

Protrusions 232 are provided on the right side wall 23 at positions adjacent to the upper wall part 231A on the inside of the accommodation wall 231. Specifically, the protrusions 232 protrude toward the first discharge filter 73 accommodated in the accommodation wall 231 in the first discharging direction, i.e., toward upstream in the first discharging direction (leftward). The protrusions 232 are at such positions corresponding to the location of the notch 731 of the first discharge filter 73 accommodated in the accommodation wall 231. The protrusions 232 are positioned inside the notch 731 of the first discharge filter 73 accommodated at the inside of the accommodation wall 231.

The first discharge filter 73 can be accommodated on the inside of the accommodation wall 231 in such a posture that the notch 731 receives therein the protrusions 232. On the other hand, the first discharge filter 73 cannot be accommodated on the inside of the accommodation wall 231 in such a posture that the notch 731 is offset from the protrusions 232 and disengaged therefrom, since the protrusions 232 abut on the first surface 73a of the first discharge filter 73.

In the present embodiment, the first discharge filter 73 has a rectangular shape having long and short sides as viewed in the left-right direction. The first discharge filter 73 can be accommodated on the inside of the accommodation wall 231 in such a posture that the short sides of the rectangle are aligned in the up-down direction.

Here, in the first discharge filter 73, the difference in length between the long sides and the short sides is small. Hence, if the notch 731 is not formed in the first discharge filter 73, a user may not properly recognize whether the shorter sides are aligned in the up-down direction or the longer sides are aligned in the up-down direction. Further, in a case where the notch 731 and the protrusions 232 are not provided, the first discharge filter 73 may be possibly accommodated on the inside of the accommodation wall 231 even if the first discharge filter 73 is incorrectly placed with the long sides aligned in the up-down direction.

Accordingly, without the protrusions 232 and notch 731, conceivably, the first discharge filter 73 could be inadvertently accommodated on the inside of the accommodation wall 231 in a wrong posture with the long sides aligned in the up-down direction.

However, according to the present embodiment, the first discharge filter 73 has the notch 731, and the right side wall 23 has the protrusions 232 engageable with the notch 731 on the inside of the accommodation wall 231. With this configuration, a user can easily recognize the posture (orientation) of the first discharge filter 73 when assembling the first discharge filter 73 to the housing 2 (right side wall 23). Thus, the first discharge filter 73 can be easily assembled to the housing 2 in a proper posture.

### [Second Elastic Member 77]

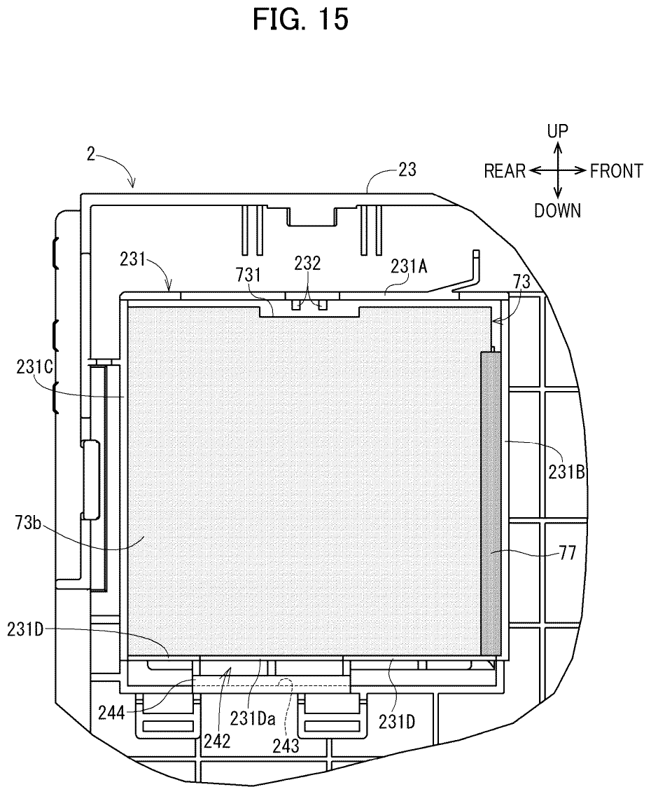

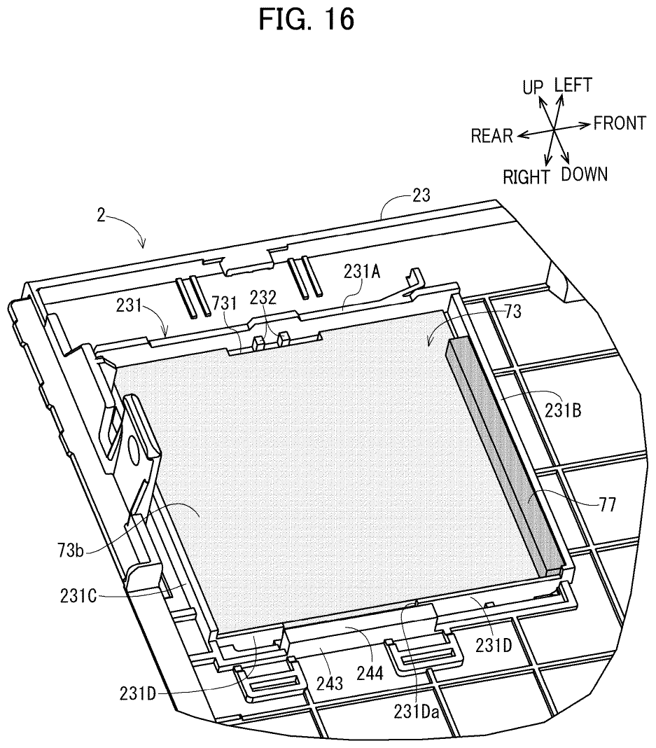

As illustrated in FIGS. 15 and 16, a second elastic member 77 is further accommodated in a space (“accommodation space”) enclosed by the accommodation wall 231 where the first discharge filter 73 is accommodated. The second elastic member 77 has an elongated parallelepiped shape. The second elastic member 77 is formed of a member having elasticity. For example, the second elastic member 77 is formed of sponge.

The second elastic member 77 is arranged adjacent to the front wall part 231B on the inside of the accommodation wall 231 such that longitudinal sides of the second elastic member 77 are aligned in the up-down direction. The second elastic member 77 is positioned between the duct front wall part 27B of the first duct 27 and the front wall part 231B of the accommodation wall 231 in the front-rear direction (see FIG. 8).

The second elastic member 77 is positioned upstream relative to the first discharge filter 73 in the first discharging direction, and is in contact with a front end portion of the second surface 73b of the first discharge filter 73. Since the second elastic member 77 is in contact with the second surface 73b of the first discharge filter 73, the second elastic member 77 functions to restrict the first discharge filter 73 accommodated in the accommodation wall 231 from being displaced toward upstream in the first discharging direction.

Since the first discharge filter 73 is restrained from moving toward the upstream in the first discharging direction, the first discharge filter 73 is less likely to abut on the first duct 27 and the first fan 71 in a state where the right side wall 23, the first duct 27, and the first fan 71 are assembled altogether. Scattering of the particles from the first discharge filter 73 can be further suppressed.

Further, the second elastic member 77 is adhesively bonded to the front wall part 231B of the accommodation wall 231, meaning that the second elastic member 77 is fixed to the accommodation wall 231. That is, the first discharge filter 73 is interposed between the second elastic member 77 and the first louver 24 in the first discharging direction. In this way, the first discharge filter 73 is temporarily fixed in position in the accommodation space enclosed by the accommodation wall 231.

When the first duct 27 and first fan 71 are assembled to the right side wall 23 with the first discharge filter 73 accommodated in the accommodation wall 231, the second elastic member 77 can suppress accidental detachment of the first discharge filter 73 from the accommodation space on the inside of the accommodation wall 231. Accordingly, workability at the time of assembly of the first duct 27 and first fan 71 to the right side wall 23 can be improved.

Alternatively, the second elastic member 77 may be adhered to the first discharge filter 73, rather than to the accommodation wall 231. In this case, the first discharge filter 73 and the second elastic member 77 affixed thereto can be mounted as a unit, rather than separately from each other, onto the interior of the accommodation wall 231. Accordingly, workability at the time of mounting the first discharge filter 73 and second elastic member 77 into the accommodation space of the accommodation wall 231 can be improved.

### [Modification to the Buffer 78]

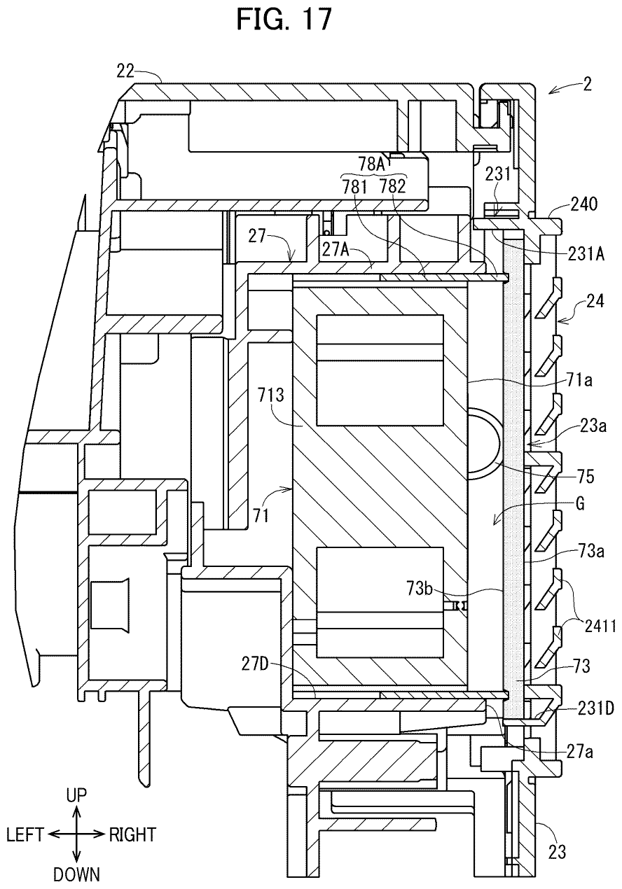

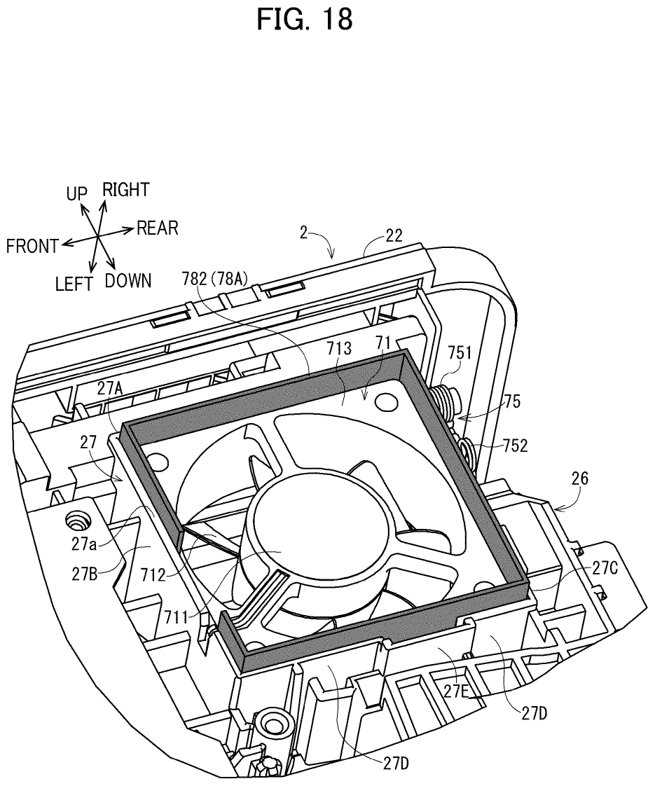

FIGS. 17 and 18 illustrate a buffer 78A according to a modification to the buffer 78 of the depicted embodiment. Just like the buffer 78A, the buffer 78A is interposed between the first fan 71 and the first duct 27.

The buffer 78A includes a buffering part 781 and an extension part 782. The buffering part 781 is positioned between the outer peripheral surface of the first fan 71 and the inner peripheral surface of the first duct 27. The extension part 782 extends from the buffering part 781 toward the right, i.e., toward downstream in the first discharging direction. Specifically, the extension part 782 extends further downstream (further rightward) relative to the first downstream end 71a of the first fan 71 and the second downstream end 27a of the first duct 27 in the first discharging direction.

The buffer 78A is formed of an elastic member such as a sponge having elasticity.

The buffering part 781 closes the gap existing between the case 713 of the first fan 71 and the first duct 27. The extension part 782 is positioned between the first fan 71 and the first discharge filter 73, and between the first duct 27 and the first discharge filter 73 in the first discharging direction. The extension part 782 has an upstream end in the first discharging direction (left end) that is in contact with the first downstream end 71a of the first fan 71 and the second downstream end 27a of the first duct 27. The extension part 782 has a downstream end in the first discharging direction (right end) that is in contact with the second surface 73b of the first discharge filter 73 accommodated in the accommodation space defined by the accommodation wall 231.

Since the extension part 782 is in contact with the second surface 73b of the first discharge filter 73 accommodated on the inside of the accommodation wall 231, the extension part 782 urges the first discharge filter 73 toward downstream in the first discharging direction. With this structure, the first discharge filter 73 is restricted from being displaced toward upstream in the first discharging direction so that the first discharge filter 73 is not detached from the accommodation wall 231.

In a case where an external force is applied onto the right side wall 23, the right side wall 23 of the housing 2 applies pressure to the first discharge filter 73 toward upstream in the first discharging direction. However, in an image-forming apparatus provided with the buffer 78A according to this modification, the extension part 782 of the buffer 78A is positioned between the first duct 27 and the first discharge filter 73. Hence, the pressure applied toward the first duct 27 (leftward pressing force) can be absorbed by the extension part 782. Accordingly, an excessive pressure is less likely to be applied from the first duct 27 to the first discharge filter 73, thereby suppressing scattering of the ozone decomposing catalyst and particles of activated charcoal contained in the first discharge filter 73 from the first discharge filter 73.

In this way, since the extension part 782 is positioned between the first discharge filter 73 (the first discharge filter 73) and the first duct 27 and is in contact with the second surface 73b of the first discharge filter 73, the extension part 78 functions in the same manner as the first elastic members 76 of the embodiment. That is, the extension part 782 of the buffer 78A according to the modification functions as the “first elastic member” of the disclosure.

Further, since the extension part 782 of the buffer 78A is employed as the first elastic member positioned between the first duct 27 and the first discharge filter 73, a separate elastic member functioning as the first elastic member is not required to be positioned between the first duct 27 and the first discharge filter 73, in addition to the buffer 78a which is positioned between the outer peripheral surface of the first fan 71 and the inner peripheral surface of the first duct 27. Hence, the number of parts can be reduced.

### [Second Fan 72, Second Duct 28, Second Discharge Filter 74, and Second Louver 25]

As illustrated in FIG. 4, the right frame 26 also includes a second duct 28. The second duct 28 penetrates the right frame 26 in the left-right direction. The second duct 28 is positioned below the first duct 27 in the right frame 26. The second fan 72 is inserted and fitted in the second duct 28. The second duct 28 extends in the left-right direction to provide an airflow in the second discharging direction which is coincident with the first discharging direction.

The second duct 28 has a rectangular cross-section taken along a plane perpendicular to the second discharging direction. That is, the second duct 28 has a rectangular shape as viewed in the left-right direction. The second fan 72 is fittingly inserted in the second duct 28. The second duct 28 accommodates the second fan 72 therein. The second duct 28 is another example of the “duct” of the disclosure.

The second fan 71 has a first downstream end 72a in the second discharging direction. The second duct 28 has a second downstream end 28a in the second discharging direction.

A second louver 25 covering the second opening 23b is provided on the right side wall 23 of the housing 2. The second louver 25 provides communication between the interior and the exterior of the housing 2. The second louver 25 is positioned rightward of the second fan 72. That is, the second louver 25 is positioned downstream of the second fan 72 in the second discharging direction. In other words, the second fan 72 is positioned upstream of the second louver 25 in the second discharging direction. The second louver 25 protrudes rightward from the outer surface of the right side wall 23.

The image-forming apparatus 1 also includes a second discharge filter 74. The second discharge filter 74 is positioned between the second fan 72 and the second louver 25 in the second discharging direction. The second discharge filter 74 is another example of the “filter” of the disclosure. The second discharge filter 74 has a rectangular shape as viewed in the left-right direction. The second discharge filter 74 has a first surface 74a facing rightward and a second surface 74b facing leftward.

The second discharge filter 74 is a honeycomb filter having a honeycomb structure formed of a filter material. The honeycomb filter as the second discharge filter 74 contains multiple cells defined by partition walls extending in the second discharging direction.

The honeycomb filter as the second discharge filter 74 may be configured by, for example, a sheet of paper carrying activated charcoal or ozone decomposing catalyst such as manganese dioxide, a metal such as aluminum, and ceramics. The second discharge filter 74 has a rectangular sheet-like shape.

The second fan 72 is an axial flow fan whose structure is the same as that of the first fan 71. The second fan 72 has a rectangular outer profile. The second fan 72 is positioned leftward of the second louver 25, i.e., upstream of the second louver 25 in the second discharging direction.

Air inside the circuit board cover 12 accommodated in the housing 2 is configured to be heated by electronic components mounted on the power circuit board 11, and, hence, the temperature of the air inside the circuit board cover 12 is likely to be elevated. As the second fan 72 rotates, the air inside the circuit board cover 12 flows toward the right, passes through the second discharge filter 74 where ozone and particles are trapped, and is finally to be discharged to the outside of the housing 2 through the second louver 25. Since the air inside the circuit board cover 12 can be discharged out of the housing 2 by the second fan 72, the temperature of the air inside the circuit board cover 12 is less likely to be elevated.

Incidentally, the second discharge filter 74 may be a filter of any type as long as the filter can remove at least minute particles such as toner from the air. The second discharge filter 74 may also be a filter capable of removing not only minute particles such as toner but also ozone from the air.

Although not illustrated in the drawings, the housing 2 also includes an accommodation wall for accommodating the second discharge filter 74. The accommodation wall has the same configuration as the accommodation wall 231 which accommodates the first discharge filter 73. The second duct 28 includes a peripheral wall (not illustrated) that surrounds the outer peripheral surface of the second fan 72. A buffer having the same configuration as the buffer 78 is positioned between the outer peripheral surface of the second fan 72 and the inner peripheral surface of the second duct 28.

A gap (similar to the gap G) is formed between the second discharge filter 74 and the second fan 72 and between the second discharge filter 74 and the second duct 28 in the second discharging direction. First elastic members (not illustrated) are positioned in the gap between the second duct 28 and the second discharge filter 74 in the second discharging direction in the same manner as the first elastic members 76. Further, in the same manner as the second elastic member 77A, a second elastic member (not illustrated) can also be accommodated in the accommodation wall that accommodates the second discharge filter 74.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image-forming apparatus comprising:
a housing having a louver;
a fan positioned inside the housing and configured to discharge air inside the housing in a discharging direction to an outside of the housing through the louver, the fan being positioned upstream of the louver in the discharging direction, the fan having a first downstream end in the discharging direction;
a duct extending in the discharging direction and accommodating the fan therein, the duct having a second downstream end in the discharging direction;
a filter positioned between the fan and the louver in the discharging direction; and
a first elastic member positioned between the filter and each of the fan and the duct in the discharging direction, the first elastic member being in contact with the filter and at least one of the second downstream end of the duct and the first downstream end of the fan.

2. The image-forming apparatus according to claim 1,
wherein the duct has a rectangular shape in cross-section taken along a plane perpendicular to the discharging direction, the duct having four corners defining the rectangular shape, the four corners including a first corner and a second corner diagonally opposing each other, and
wherein the first elastic member is provided only at each of the first corner and the second corner among the four corners of the duct.

3. The image-forming apparatus according to claim 1, further comprising a buffer including:
a buffering part positioned between an outer peripheral surface of the fan and an inner peripheral surface of the duct; and
an extension part extending from the buffering part toward downstream in the discharging direction, the extension part having a downstream end that is positioned further downstream in the discharging direction relative to the first downstream end of the fan and the second downstream end of the duct, the extension part functioning as the first elastic member.

4. The image-forming apparatus according to claim 1, further comprising a buffer positioned between an outer peripheral surface of the fan and an inner peripheral surface of the duct.

5. The image-forming apparatus according to claim 1,
wherein the first elastic member is a sponge.

6. The image-forming apparatus according to claim 1, further comprising a grounding member in contact with the filter for grounding of the filter, the grounding member urging the filter toward downstream in the discharging direction.

7. The image-forming apparatus according to claim 6,
wherein the duct has a peripheral wall extending in the discharging direction and defining an outer shape of the duct, and
wherein the grounding member is a coil spring, the coil spring being supported by the peripheral wall of the duct.

8. The image-forming apparatus according to claim 1,
wherein the first elastic member is adhesively bonded to the filter.

9. The image-forming apparatus according to claim 1, further comprising a second elastic member,
wherein the housing comprises an accommodation wall defining an accommodation space in which the filter is accommodated, the second elastic member being also accommodated in the accommodation space.

10. The image-forming apparatus according to claim 9,
wherein the second elastic member is adhesively bonded to the filter.

11. The image-forming apparatus according to claim 9,
wherein the second elastic member is adhesively bonded to the accommodation wall.

12. The image-forming apparatus according to claim 1,
wherein the housing comprises an accommodation wall defining an accommodation space in which the filter is accommodated,
wherein the filter has a notch, and
wherein the housing further includes a protrusion positioned in the accommodation space and protruding in the discharging direction toward the filter, the protrusion being positioned inside the notch of the filter accommodated in the accommodation space.
